(19) United States
(12) Patent Application Publication
(10) Pub. No.: US 2018/0141868 A1
(43) Pub. Date: May 24, 2018

(54) ARTICLE MADE FROM REFRACTORY MATERIAL FOR CONTACT WITH A LIQUID METAL OR ALLOY, A METHOD FOR MANUFACTURE, USE AND METHOD OF USE OF SAME

(71) Applicant: LES PRODUITS INDUSTRIELS DE HAUTE TEMPERATURE PYROTEK INC., Sherbrooke (CA)

(72) Inventor: Saied Afshar, Canton de Hatley (CA)

(21) Appl. No.: 15/572,435

(22) PCT Filed: Mar. 15, 2016
(86) PCT No.: PCT/CA2016/050284

§ 371 Date: Nov. 7, 2017

Related U.S. Application Data
(60) Provisional application No. 62/158,232, filed on May 7, 2015.

(51) Int. Cl. C04B 35/185; C04B 35/10; C04B 35/64; B22D 21/00; B22D 41/02; B22D 35/00

(52) U.S. Cl. CPC C04B 35/185; C04B 35/10; C04B 35/64; B22D 21/007; B22D 41/02; B22D 35/00; C04B 2235/9676; C04B 2235/3463; C04B 2235/3244; C04B 2235/3222; C04B 2235/3418; C04B 2235/5418; C04B 2235/656; C04B 2235/3217

(57) ABSTRACT

The invention relates to a use of a refractory material for contact with a liquid metal or alloy, a method for the manufacture of an article made of said material, the article so obtained and a method of use of said article. The refractory material is obtained from a mixture comprising from 0 wt. % to 40 wt. % of aggregates and/or fmes of zirconia; from 10 wt. % to 50 wt. % of aggregates and/or fmes of alumina; and from 20 wt. % to 50 wt. % of aggregates and/or fines of mullite; formed into a desired shape and then subjected to a heating treatment at a temperature of from 750° C. to 1500° C.

### FIELD OF THE INVENTION

The present invention relates to a use of a refractory material for contact with a liquid metal or a liquid metal alloy, especially an Al—Li alloy, a method of manufacture of an article made of said refractory compound, the article so obtained and a method of use of said article.

### BRIEF DESCRIPTION OF PRIOR ART

Articles intended to be placed in contact with liquid metals or liquid metal alloys are made of refractory materials. Such articles may be used for the melting, transferring and/or casting of said liquid metals or liquid metals alloys. In this regard, it is well known that liquid metals and liquid metal alloys are corrosive, and therefore when contacting refractory materials of articles made of them, corrosion and/or erosion occur rendering the service life of said articles limited in time.

Such corrosion and/or erosion of refractory materials are particularly important with aluminum-lithium alloys which are well known to be highly corrosive because of the presence of lithium. Indeed, when an Al—Li alloy is contacted with a refractory material, such as for example a refractory material made of alumino-silicate (which is frequently employed in Al—Li alloy industries), this refractory material is attacked by molten aluminum-lithium alloy during service.

Also, it is to be noted that lithium is known to be one of the most aggressive alloying element against refractory materials, said lithium reacting with high silica-based compounds of refractory materials. Also, the corrosion products, due to lithium attack, are frequently Li₂SiO₃ and Li₃AlSiO₅. These products are friable and can be removed (eroded) by molten metal move. Thus, the service life of refractory materials is seriously limited by corrosion and/or erosion. An example of the corrosion/erosion observed is illustrated in FIG. 6 of the drawings. This FIG. 6 represents a picture of a partial cross-sectional view of a launder made of alumino-silicate after having been contacted by a liquid Aluminum-Lithium alloy. More particularly, such corrosion/erosion is visible by the bleached area appearing at the interface where the liquid aluminum-lithium alloy contacted the refractory material.

Therefore, there is a very strong need in the industry for a refractory material which will be resistant to the corrosive attacks and/or erosion caused by liquid metals or liquid metal alloys, and especially when in continuous contact with molten metals or metal alloys such as for example corrosive Al—Li alloys (e.g. Al—Li alloys having a Li content of at least 0.5 wt. %, preferable from 0.5 to 3 wt. %).

The Applicant has now discovered various embodiments overcoming drawbacks associated with refractory materials used up to now (e.g. refractory material made alumino-silicate) for contact with liquid metals or liquid metal alloys, said refractory materials being part of articles used for the melting, transferring and/or casting of said liquid metals or alloys, especially when said alloy is an Al—Li alloy.

More particularly, the Applicant has discovered that an existing refractory material which was used in field of activity that is very different of the one related to liquid metals or liquid metal alloys, that is the field of glass industries, shows surprising and unexpected properties when put into contact with liquid metals or liquid metal alloys, an even when put in contact with a highly corrosive Al—Li alloy. Indeed, this very particular refractory material showed to be corrosion resistant and erosion resistant.

More particularly, this refractory material used with liquid glass is designed to resist to silicium attacks at very high temperature (i.e. above 1400° C.). This constitutes a fundamental change when compared to with liquid aluminum (i.e. about 700° C.).

Also, it is known to persons skilled in the art that SiO₂ is harmful for glass and aluminum alloys. Nevertheless, because of its high thermal shock resistance, free silica or silica-based compounds are still widely employed in the refractory materials for aluminum industry. However, the presence of free silica is determinant for chemical resistance of refractories against the aluminum attack.

Up to now, in order to solve this problem, some additives, called non-wetting agents, were employed. In most of the case, the non-wetting additives improve the corrosion resistance of refractories. However, in the case of Al—Li alloys, the presence of non-wetting agent is not sufficient to prevent the corrosion attack by lithium vapor penetration.

Thus, the selected refractory material present an unexpected innovation for Al—Li application, since the amount of free silica is reduced to almost nil via an appropriate formulation and combination of the adequate starting material. Therefore, without the need of non-wetting additives, the present products could resist to Al—Li alloys. Moreover, the thermal conductivity and the thermal shock resistance of the proposed products is sufficiently good to be used in direct contact with molten aluminum.

### SUMMARY OF THE INVENTION

An embodiment of the invention relates to a use of a refractory material for contact with a liquid metal or a liquid metal alloy,

wherein the refractory material is obtained from a mixture comprising:
from 0 wt. % to 40 wt. %, preferably from 5 wt. % to 40 wt. %, of aggregates and/or fines of zirconia;
from 10 wt. % to 50 wt. % of aggregates and/or fines of alumina; and
from 20 wt. % to 50 wt. % of aggregates and/or fines of mullite;

formed into a desired shape and then subjected to a heating treatment at a temperature of from 750° C. to 1500° C.

Another embodiment of the invention relates to a method for the manufacture of an article made of a refractory material for contact with a liquid metal or a liquid metal alloy,

wherein said method comprises the steps of:
a) providing a mixture comprising:
   from 0 wt. % to 40 wt. %, preferably from 5 wt. % to 40 wt. %, of aggregates and/or fines of zirconia;
   from 10 wt. % to 50 wt. % of aggregates and/or fines of alumina; and
   from 20 wt. % to 50 wt. % of aggregates and/or fines of mullite;
b) forming the mixture into a desired shape to obtain a shaped mixture; and
c) subjecting the shaped mixture obtained from step b) to a heating treatment at a temperature of from 750° C. to 1500° C.

Another embodiment of the invention relates to a method for the manufacture of an article made of a refractory material for contact with a liquid metal or a liquid metal alloy, wherein said method comprises the steps of:
a) providing a mixture comprising:
   from 0 wt. % to 40 wt. %, preferably from 5 wt. % to 40 wt. %, of aggregates and/or fines of zirconia;
   from 10 wt. % to 50 wt. % of aggregates and/or fines of alumina;
   from 20 wt. % to 50 wt. % of aggregates and/or fines of mullite;
   an amount of aggregates and/or fines of calcium aluminate; and
   an amount of colloidal silica;
b) forming the mixture into a desired shape and then allowing it to set at room temperature between 4 to 24 hours; and
c) subjecting the set mixture obtained from step b) to a heating treatment at a temperature of from 750° C. to 1500° C.

Another embodiment of the invention relates to an article made of a refractory material for contact with a liquid metal or a liquid metal alloy, wherein said refractory material is obtained from a mixture comprising:
from 0 wt. % to 40 wt. %, preferably from 5 wt. % to 40 wt. %, of aggregates and/or fines of zirconia;
from 10 wt. % to 50 wt. % of aggregates and/or fines of alumina; and
from 20 wt. % to 50 wt. % of aggregates and/or fines of mullite;

formed into a desired shape and then subjected to a heating treatment at a temperature of from 750° C. to 1500° C.

Another embodiment of the invention relates to a method for melting, transferring and/or casting a liquid metal or a liquid metal alloy, said method comprising a step of contacting the article defined hereinabove with the liquid metal or the liquid metal alloy.

### DETAILED DESCRIPTION OF THE INVENTION

As mentioned above, an embodiment of the invention relates to the use of a refractory material for contact with a liquid metal or a liquid metal alloy,

wherein the refractory material is obtained from a mixture comprising:
from 0 wt. % to 40 wt. %, preferably from 5 wt. % to 40 wt. %, of aggregates and/or fines of zirconia;
from 10 wt. % to 50 wt. % of aggregates and/or fines of alumina; and
from 20 wt. % to 50 wt. % of aggregates and/or fines of mullite;

formed into a desired shape and then subjected to a heating treatment at a temperature of from 750° C. to 1500° C.

Another embodiment of the invention relates to the use defined hereinabove, wherein the mixture further comprises an amount of at least one of calcium aluminate and colloidal silica, and wherein the mixture after having been formed into a desired shape, is further allowed to set at room temperature between 4 and 24 hours, before being subjected to the heating treatment at the temperature of 750° C. to 1500° C.

Another embodiment of the invention relates to the use defined hereinabove, wherein wherein the calcium aluminate represents from 0 to 15 wt. % of the total weight of zirconia, alumina and mullite, and the colloidal silica represents from 0 to 20 wt. % of the total weight of zirconia, alumina and mullite.

Another embodiment of the invention relates to the use defined hereinabove, wherein wherein the mixture is a premix of
about 20 wt. % of aggregates and/or fines of zirconia;
about 46 wt. % of aggregates and/or fines of alumina; and
about 34 wt. % of aggregates and/or fines of mullite;

in admixture, with respect to the total weight of the premix, with
about 0.5 wt. %,of fine and/or aggregates of calcium aluminate; and
about 9 wt. % of a colloidal silica.

Another embodiment of the invention relates to the use defined hereinabove, wherein the mesh size of aggretates of zirconia varies from 325 to 4 mesh, the mesh size of aggregares of alumina varies from 325 to 4 mesh, and the mesh size of aggregates of mullite varies from 325 to 4 mesh.

Another embodiment of the invention relates to the use defined hereinabove, wherein the mesh size of aggregates of zirconia varies from 325 to 4 mesh, the mesh size of aggregates of alumina varies from 325 to 4 mesh, and the mesh size of aggregates of mullite varies from 325 to 4 mesh, the mesh size of aggregates of calcium aluminate is 325 to 4 mesh, and the colloidal silica has a solid weight content of about 40%.

Another embodiment of the invention relates to the use defined hereinabove, wherein the zirconia is zirconium oxide, or the zirconia and the mullite are obtained from aggregates and/or fines forming a zirconia-mullite mixture.

Another embodiment of the invention relates to the use defined hereinabove, wherein the refractory material is the constitutive material of an article for the melting, transfer and/or casting of said liquid metal or liquid metal alloy, said article having at least a portion thereof in direct contact with said liquid metal or liquid metal alloy.

Another embodiment of the invention relates to the use defined hereinabove, wherein the article is a crucible, a launder, a trough, a dam, a T-plate, a plunger, a pin, a down spout, a lining, a filter bowl, a box or a part thereof, for direct contact with the liquid metal or metal alloy.

Another embodiment of the invention relates to the use defined hereinabove, wherein the article is a launder or a part thereof for direct contact with the liquid metal or metal alloy.

Another embodiment of the invention relates to the use defined hereinabove, wherein the liquid metal alloy is an Al—Li alloy.

Another embodiment of the invention relates to the use defined hereinabove, wherein the Al—Li alloy has from 1 wt. % to 3 wt. % lithium content.

Another embodiment of the invention relates to the use defined hereinabove, wherein the forming into a desired shape consists of pouring the mixture into a mould.

Another embodiment of the invention relates to the use defined hereinabove, wherein the heating treatment is a firing.

As mentioned above, another an embodiment of the invention relates to the method for the manufacture of an article made of a refractory material for contact with a liquid metal or a liquid metal alloy,

wherein said method comprises the steps of:
a) providing a mixture comprising:
   from 0 wt. % to 40 wt. %, preferably from 5 wt. % to 40 wt. %, of aggregates and/or fines of zirconia;
   from 10 wt. % to 50 wt. % of aggregates and/or fines of alumina; and
   from 20 wt. % to 50 wt. % of aggregates and/or fines of mullite;
b) forming the mixture into a desired shape; and
c) subjecting the mixture obtained from step b) to a heating treatment at a temperature of from 750° C. to 1500° C.

As mentioned above, another embodiment of the invention relates to the method for the manufacture of an article made of a refractory material for contact with a liquid metal or a liquid metal alloy, wherein said method comprises the steps of:
a) providing a mixture which is a premix of:
   from 0 wt. % to 40 wt. %, preferably from 5 wt. % to 40 wt. %, of aggregates and/or fines of zirconia;
   from 10 wt. % to 50 wt. % of aggregates and/or fines of alumina; and
   from 20 wt. % to 50 wt. % of aggregates and/or fines of mullite;
in admixture, with respect to the total weight of the premix, with:
   from 0 to 15 wt. % fines and/or aggregates of calcium aluminate; and
   from 0 to 20 wt. % of colloidal silica;
b) forming the mixture of step a) into a desired shape and then allowing it to set at room temperature between 4 to 24 hours, to obtained a set and shaped mixture; and
c) subjecting the set and shaped mixture of step b) to a heating treatment at a temperature of from 750° C. to 1500° C.

Another embodiment of the invention relates to the method defined hereinabove, wherein the mixture comprises a premix of
about 20 wt. % of aggregates and/or fines of zirconia;
about 46 wt. % of aggregates and/or fines of alumina; and
about 34 wt. % of aggregates and/or fines of mullite;

in admixture, with respect to the total weight of the premix, with
about 0.5 wt. %,of fines and/or aggregates of calcium aluminate; and
about 9 wt. % of a colloidal silica.

Another embodiment of the invention relates to any one of the methods defined hereinabove, wherein the mesh size of aggregates of zirconia varies from 325 to 4 mesh, the mesh size of aggregates of alumina varies from 325 to 4 mesh, and the mesh size of aggregates of mullite varies from 325 to 4 mesh.

Another embodiment of the invention relates to any one of the methods defined hereinabove, wherein the mesh size of aggregates of zirconia varies from 325 to 4 mesh, the mesh size of aggregates of alumina varies from 325 to 4 mesh, and the mesh size of aggregates of mullite varies from 325 to 4 mesh, the mesh size of aggregates of calcium aluminate is 325 to 4 mesh, and the colloidal silica has a solid weight content of about 40%.

Another embodiment of the invention relates to any one of the methods defined hereinabove, wherein the zirconia is zirconium oxide, or the zirconia and the mullite are obtained from aggregates and/or fines forming a zirconia-mullite mixture.

Another embodiment of the invention relates to any one of the methods defined hereinabove, wherein the refractory material is the constitutive material of an article for the melting, transfer and/or casting of said liquid metal or liquid metal alloy, said article having at least a portion thereof in direct contact with said liquid metal or liquid metal alloy.

Another embodiment of the invention relates to the method defined hereinabove, wherein the article is a crucible, a launder, a trough, a dam, a T-plate, a plunger, a pin, a down spout, a lining, a filter bowl, a box or a part thereof, for direct contact with the liquid metal or metal alloy.

Another embodiment of the invention relates to the method defined hereinabove, wherein the article is a launder or a part thereof for direct contact with the liquid metal or metal alloy.

Another embodiment of the invention relates to any one of the methods defined hereinabove, wherein the liquid metal alloy is an Al—Li alloy.

Another embodiment of the invention relates to any one of the methods defined hereinabove, wherein the liquid metal alloy is an Al—Li alloy having from 1 wt. % to 3 wt. % lithium content.

Another embodiment of the invention relates to any one of the methods defined hereinabove, wherein the forming into a desired shape consists of pouring the mixture into a mould.

Another embodiment of the invention relates to any one of the methods defined hereinabove, wherein the heating treatment is a firing.

As mentioned above, another embodiment of the invention relates an article made of a refractory material for contact with a liquid metal or a liquid metal alloy, wherein said refractory material is obtained from a mixture comprising:
from 0 wt. % to 40 wt. %, preferably from 5 wt. % to 40 wt. %, of aggregates and/or fines of zirconia;
from 10 wt. % to 50 wt. % of aggregates and/or fines of alumina; and
from 20 wt. % to 50 wt. % of aggregates and/or fines of mullite;

formed into a desired shape and then subjected to a heating treatment at a temperature of from 750° C. to 1500° C.

Another embodiment of the invention relates to the article defined hereinabove, wherein the mixture further comprises an amount of at least one of calcium aluminate and colloidal silica, and wherein the mixture after having been formed into a desired shape, is further allowed to set at room temperature between 4 and 24 hours, before being subjected to the heating treatment at the temperature of 750° C. to 1500° C.

Another embodiment of the invention relates to the article defined hereinabove, wherein the calcium aluminate represents from 0 to 15 wt. % of the total weight of zirconia, alumina and mullite, and the colloidal silica represents from 0 to 20 wt. % of the total weight of zirconia, alumina and mullite.

Another embodiment of the invention relates to the article defined hereinabove, wherein the mixture comprises a premix of:
about 20 wt. % of aggregates and/or fines of zirconia;
about 46 wt. % of aggregates and/or fines of alumina; and
about 34 wt. % of aggregates and/or fines of mullite;

in admixture, with respect to the total weight of the premix, with:
about 0.5 wt. % of aggregates and/or fines of calcium aluminate; and
about 9 wt. % of a colloidal silica.

Another embodiment of the invention relates to the article defined hereinabove, wherein the mesh size of aggregates of zirconia varies from 325 to 4 mesh, the mesh size of aggregates of alumina varies from 325 to 4 mesh, and the mesh size of aggregates of mullite varies from 325 to 4 mesh.

Another embodiment of the invention relates to the article defined hereinabove, wherein the mesh size of aggregates of zirconia varies from 325 to 4 mesh, the mesh size of aggregates of alumina varies from 325 to 4 mesh, and the mesh size of aggregates of mullite varies from 325 to 4 mesh, the mesh size of aggregates of calcium aluminate is 325 to 4 mesh, and the colloidal silica has a solid weight content of about 40%.

Another embodiment of the invention relates to the article defined hereinabove, wherein the zirconia is zirconium oxide, or the zirconia and the mullite are obtained from aggregates and/or fines forming a zirconia-mullite mixture.

Another embodiment of the invention relates to the article defined hereinabove, wherein the refractory material is the constitutive material of the article for the melting, transfer and/or casting of said liquid metal or liquid metal alloy, said article having at least a portion thereof in direct contact with said liquid metal or liquid metal alloy.

Another embodiment of the invention relates to the article defined hereinabove, wherein the article is a crucible, a launder, a trough, a dam, a T-plate, a plunger, a pin, a down spout, a lining, a filter bowl, a box or a part thereof, for direct contact with the liquid metal or metal alloy.

Another embodiment of the invention relates to the article defined hereinabove, wherein the article is a launder or a part thereof for direct contact with the liquid metal or metal alloy.

Another embodiment of the invention relates to the article defined hereinabove, wherein the liquid metal alloy is an Al—Li alloy.

Another embodiment of the invention relates to the article defined hereinabove, wherein the Al—Li alloy has from 1 wt. % to 3 wt. % lithium content.

Another embodiment of the invention relates to the article defined hereinabove, wherein the forming into a desired shape consists of pouring the mixture into a mould.

Another embodiment of the invention relates to the article defined hereinabove, wherein the heating treatment is a firing.

As mentioned above, another embodiment of the invention relates a method for melting, transferring and/or casting a liquid metal or a liquid metal alloy, said method comprising a step of contacting the article as defined hereinabove, with the liquid metal or the liquid metal alloy.

### BRIEF DESCRIPTION OF THE DRAWINGS

The present invention will be better understood with reference to the following drawings:

FIG. 1 is a sketch of a sample used in the experimental part of the disclosure.

FIG. 2 is a photograph of a display of 12 samples tested according to the experimental part of the disclosure.

FIG. 3 is a photograph of cross sectional view a sample A according to the experimental part of the disclosure.

FIG. 4 is a photograph of a cross sectional view of a sample B according to the experimental part of the disclosure.

FIG. 5 is a photograph of a cross sectional view of a sample C according to the experimental part of the disclosure.

FIG. 6 is a photograph of a partial cross sectional view of a launder (called product B) according to the experimental part of the disclosure.

FIG. 7 is a photograph of two halves of a brick A, after a complete immersion test in liquid Al—Li alloy (1%), according to the experimental part of the disclosure.

FIG. 8 is a photograph of two halves of a brick B, after a complete immersion test in liquid Al—Li alloy (1%), according to the experimental part of the disclosure.

FIG. 9 is a photograph of a display of 6 samples treated with an corrosion-resistant coating, before being subjected to a test according to the experimental part of the disclosure.

FIG. 10 is a photograph of samples made of the refractory material Zr-20 C and tested according to the experimental part of the disclosure.

FIG. 11 represents a diagram of the thermal conductivities of refractory material ZR-20 C having been heat treated at 1450° C.

### EXAMPLES

### Example 1

### Comparative Corrosion Tests of 3 Refractory Materials Currently Used for Direct Contact with Liquid Aluminum-Lithium Alloys

Objectives
1. Evaluation of the corrosion resistance of 3 refractory products commonly used for direct contact with liquid aluminum-lithium alloys.
2. Classification of said 3 refractory materials according to their behaviors vis-à-vis of aluminum-lithium alloys.

Procedure

The test was a comparative test between 3 refractory materials currently used for direct contact with liquid aluminum-lithium alloys in order to evaluate the kinetic of corrosion in refractory materials.

Preparation of Samples

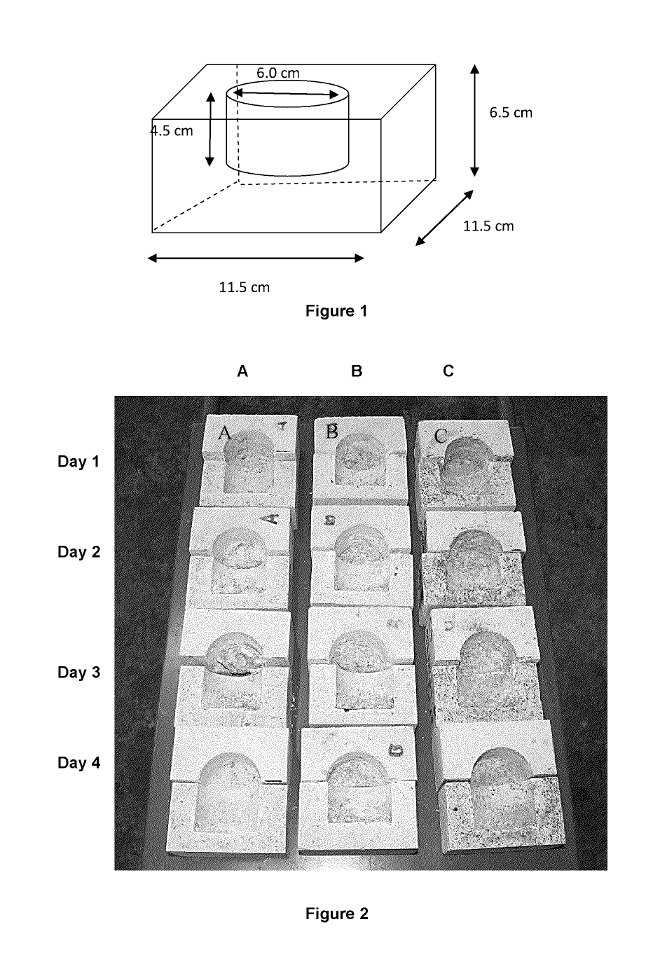

FIG. 1 illustrates the shape and size of samples that were tested. Each sample was a monolithic parallelepiped of 11.5 cm wide, 11.5 cm depth and 6.5 cm high, provided its top surface with a vertical cylindrical cavity having a diameter of 6.0 cm and a depth of 4.5 cm.

More particularly, each sample was prepared according to any techniques well known in the art, and then cut and machined according to techniques well known in the art. As a non-limiting example, said samples were obtained by moulding and cavities made by drilling.

More particularly, for performing the test, 4 samples of three different refractory materials were prepared. Said refractory materials were the following Pyrocast FS73AL (material A), Versaflow® Thermax® Al Adtech® (material B) and Pyrocast FS44AL (material C). It is to be noted that refractory materials A and B were equivalent in terms of silica content.

More particularly, the refractory materials A, B and C have the following characteristics:

A—Pyrocast FS73AL

This product is a fused silica.

Physical Properties

| | Temperature | | |
|---|---|---|---|
| | After heating to | After heating to | After heating to |
| | 230° F. (110° C.) | 932° F. (500° C.) | 1500° F. (815° C.) |
| Permanent | 0.0% | −0.1% | −0.1% |
| Linear | | | |
| Change | | | |
| Density | 132 lb/ft³ | 128 lb/ft³ | 128 lb/ft³ |
| | 2.11 g/cm³ | 2.05 g/cm³ | 2.05 g/cm³ |
| | 2110 kg/m³ | 2050 kg/m³ | 2050 kg/m³ |
| Modulus of | 1190 psi | 860 psi | 620 psi |
| Rupture | 8.2 MPa | 5.9 MPa | 4.3 MPa |
| | 84 kg/cm² | 60 kg/cm² | 44 kg/cm² |
| Cold | 9500 psi | 6200 psi | 4800 psi |
| Crushing | 66 MPa | 43 MPa | 33 MPa |
| Strength | 670 kg/cm² | 440 kg/cm² | 340 kg/cm² |

Maximum service temperature of 2200° F. (1200° C.)
Thermal conductivity

| ° F. (° C.) | BTU · in/ft² · hr · F (W/m · K) |
|---|---|
| 300 (150) | 8.39 (1.21) |
| 600 (316) | 7.70 (1.11) |
| 800 (427) | 7.49 (1.08) |
| 1000 (538) | 7.42 (1.07) |
| 1200 (649) | 7.49 (1.08) |
| 1500 (816) | 7.90 (1.14) |
| 1800 (982) | 8.67 (1.25) |
| 2000 (1093) | 9.43 (1.36) |
| 2200 (1204) | 10.33 (1.49) |

Composition

| Material | Weight (wt. %) |
|---|---|
| SiO₂ | 73.4 |
| Al₂O₃ | 22.7 |
| CaO | 3.7 |
| Other | 0.2 |

B—Versaflow® Thermax® Al Adtech®

This product is a vitreous silica-based, Low-cement casting mix with aluminum-resistant additive. It chemical analysis (calcined basis) is as follows:

| Chemical analysis (calcined basis) | |
|---|---|
| Silica - SiO₂ | 73.1% |
| Alumina - Al₂O₃ | 25.4% |
| Titania - TiO₂ | 0.01% |
| Iron Oxide - Fe₂O₃ | 0.01% |
| Lime - CaO | 2.2% |
| Magnesia - MgO | 0.01% |
| Alkalies - Na₂O + K₂O | 0.02% |
| Physical Properties | Vibration cast |
| Maximum Recommended Temperature | 1370° C. |
| Quantity Required | 2000 Kgs/m³ |
| Water required for mixing per 100 Kgs | 6.0-7.0 Litres |
| | Approximately |
| Bulk Density | Kgs/m³ |
| After Heating at 105° C. | 1950-2150 |
| Modulus of rupture - ASTM C133 and C865 | MPa |
| After Heating at 105° C. | 6.0-11.0 |
| After Heating at 815° C. | 6.0-12.0 |
| Cold Crushing Strength - ASTM C133 and C865 | MPa |
| After Heating at 105° C. | 60.0-90.0 |
| After Heating at 815° C. | 50.0-70.0 |
| Permanent Linear Change - ASTM C133 and C865 | |
| After Heating at 815° C. | 0.0% |
| Thermal Conductivity | W/mK |
| At 200° C. | 1.35 |
| At 400° C. | 1.33 |
| At 600° C. | 1.27 |
| At 800° C. | 1.44 |
| At 1000° C. | 1.57 |
| Shelf Life (under proper storage conditions) | 180 days |

C—Pyrocast FS44AL

This product is a fused silica.

Physical Properties

| | |
|---|---|
| Density | 141 lb/ft³ (2259 kg/m³) |
| Modulus of | 1195 psi (8.2 MPa) |
| Rupture | |
| Cold Crushing | 9300 psi 64.1 MPa |
| Strength | |

Maximum service temperature of 2012° F. (1100° C.)
Thermal conductivity

| ° F. (° C.) | BTU · in/ft² · hr · F (W/m · K) |
|---|---|
| 752 (400) | 5.50 (0.79) |
| 1022 (550) | 7.50 (1.08) |
| 1292 (700) | 10.00 (1.45) |

Composition

| Material | Weight (wt. %) |
|---|---|
| SiO₂ | 44 |
| SiC | 29 |
| Al₂O₃ | 22 |
| CaO | 4 |

The aluminum-lithium alloy used for the test was an aluminum alloy known under the trademark «AIRWARE®», and comprising in addition to the aluminum the following constituents:
Li: 1 wt. %
Cu: 3 wt. %
Zr: 0.2 wt. %
Ag: 0.3 wt. %.

Also, a salt containing lithium chloride was used. This salt is known under the name of “Pyrolith” salt and consists of a mixture of 45 wt. % lithium chloride and 55 wt. % potassium chloride.

Corrosion Test

The corrosion test comprised the following steps:
1. Each sample were placed in an electric oven and heated at 850° C., with a programmed temperature rise of 3° C./min.
2. Once the temperature of 850° C. was reached, then 150 gr. of the liquid aluminum-lithium alloy defined above was poured into the cylindrical cavity of each sample.
3. Immediately after having poured the liquid aluminum-lithium alloy, 10 gr. of the “Pyrolith” salt defined above was added at the surface of the liquid aluminum-lithium alloy.
4. Every 24 hours, during 4 days (the total duration of the test), one sample made of the refractory materials A, B and C was removed from the oven, emptied from its content, photographed.
5. Each sample obtained from step 4 was cut into two halves, perpendicularly to a basal surface of the sample, for evaluation and classification, and photographed.

Classification

The classification was carried out according to a well known classification test which is known as the “Alcan classification”. This test is based on observation of tested samples according to the following table:

| | Category | Observation |
|---|---|---|
| 1 | “GOOD” resistance | low adherence |
| | | no infiltration |
| | | no brittleness and/or cracking |
| 2 | “GOOD to MODERATE” resistance | high adherence |
| | | no infiltration |
| | | no brittleness and/or cracking |
| 3 | “MODERATE” resistance | high adherence |
| | | low infiltration |
| | | no brittleness and/or cracking |
| 4 | “POOR to MODERATE” resistance | high adherence |
| | | high infiltration |
| | | no brittleness and/or cracking |
| 5 | “POOR” resistance | high adherence |
| | | high infiltration |
| | | low brittleness and/or |
| | | cracking |
| 6 | “NO” resistance | high adherence |
| | | high infiltration |
| | | highbrittleness and/or |
| | | cracking |

In this table, the significance of the terms in the «Observation» column is:
low adherence: the metal layer on the samples can be removed by rubbing with the fingers;
high adherence: the metal layer on the samples cannot be removed by rubbing with the fingers;
no infiltration: the sample cross sections show no signs of infiltration visible to the naked eye;
low infiltration: the sample cross sections show signs of infiltration visible to the naked eye on an average thickness less than 1 mm;
high infiltration: the sample cross sections show signs of infiltration on an average thickness larger than 1 mm;
no brittleness: the sample cross sections show a smooth surface which will not flake away when rubbed with the fingers;
low brittleness: the sample cross sections show a rough surface which will not flake away when rubbed with the fingers;
high brittleness: the sample cross sections show a rough surface which can be flaked away by rubbing with the fingers;
no cracking: the samples show no signs of cracking from the test visible to the naked eye on their exterior surfaces or on their cross sections.

Results

As evidenced in FIG. 2, twelve samples were tested (four sample made of material A, four samples made of material B and four samples made of material C). According to step 5 of the corrosion test, each sample was cut into two halves, perpendicularly to a basal surface of the sample. Both halves of a same sample were laid on a table with one half showing its top surface and one half showing the cross section view of the sample (i.e. cross sectional cut).

At the top of FIG. 2, the first row represents sample at day 1, the second represents samples at day 2, the third row represents samples at day 3 and the fourth row represents samples at day 4, and the first column represents samples made of the refractory material A, the second column represents samples made of the refractory material B, and the third column represents the samples made of the refractory material C.

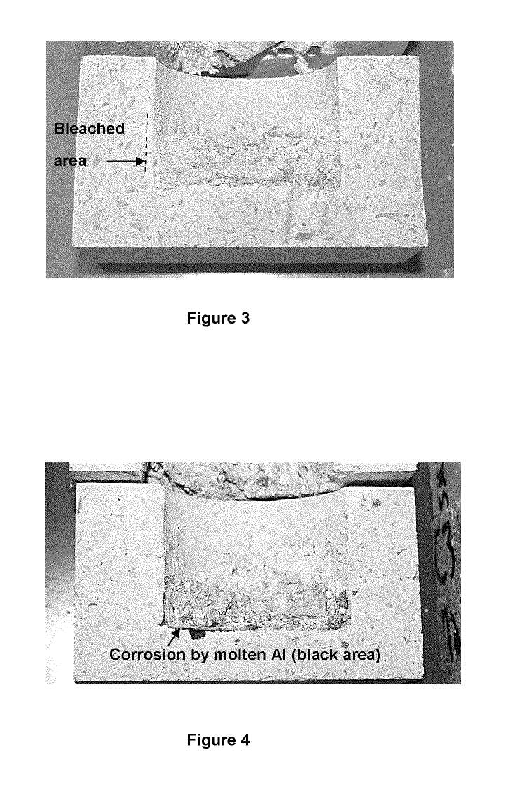

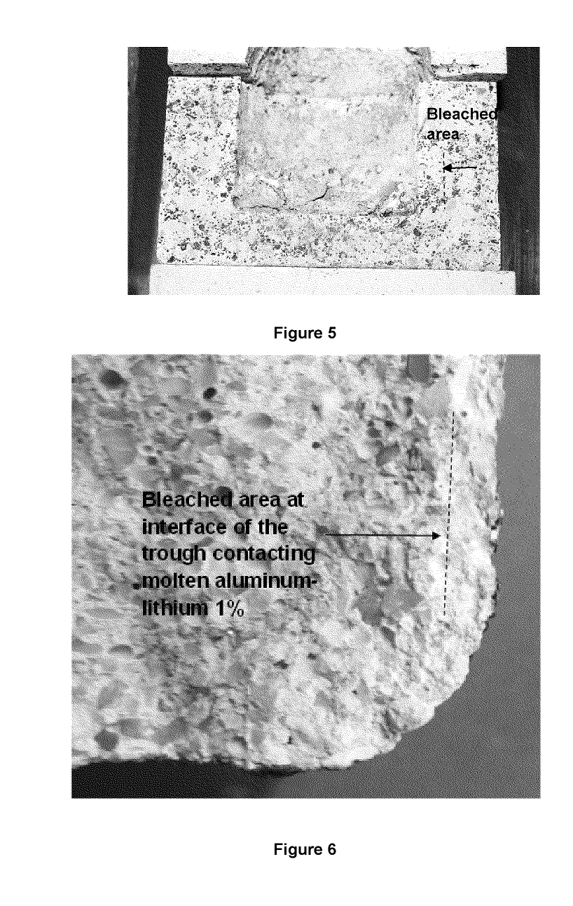

At the interface of the liquid aluminum-lithium alloy with the refractory material, a bleached area was is visible at naked eye on each of the 12 samples. The depth of this area for samples A and B was about 2 mm (see FIGS. 3 and 4) and remained unchanged during the test. However, concerning sample C, this area reached 1 cm (see FIG. 5).

The bleached area observed in each samples was the result of a chemical reaction of the refractory material with the liquid aluminum-lithium alloy, especially the lithium in vapor phase.

Also, a portion of a launder which was commercially used during the commercial casting of a liquid aluminum-lithium alloy as defined in example 1, was observed. This launder was made of Versaflow® Thermax® Al Adtech® as defined hereinabove and revealed (see FIG. 6) the presence of a bleached area which is similar to the one observed in the test carried out in example 1. Thus, this bleached area was representing a corroded area and consequently the above-mentioned “Alcan classification” can be used to evaluate the resistance to corrosion of samples.

Therefore, from the foregoing, it appears that all the 12 samples testes were classified, according to the “Alcan classification” as being “No. 4—poor to moderate resistance”. However, because of the depth of the bleached area noted in samples C, this one was clearly disadvantaged compared to products A and B. Moreover, the lack of corrosion by the liquid aluminum-lithium alloy (black area) in the product A, provides a certain advantage compared to product B.

### Example 2

To better evaluate the resistance to corrosion of the refractory material A and B defined in example 1, an immersion test was further carried out.

More particularly, a brick made of the refractory material A and a brick made of the refractory material B were immersed into liquid aluminum-lithium alloy (1%). More particularly, each brick was immersed in 2 Kg of a liquid aluminum-lithium alloy (1%), 20 gr. of a “Pyrolith” salt as defined in example 1 having been added to the surface of the liquid alloy, after melting to reduce the evaporation of metallic elements. The test lasts 4 days without any interruption during the test.

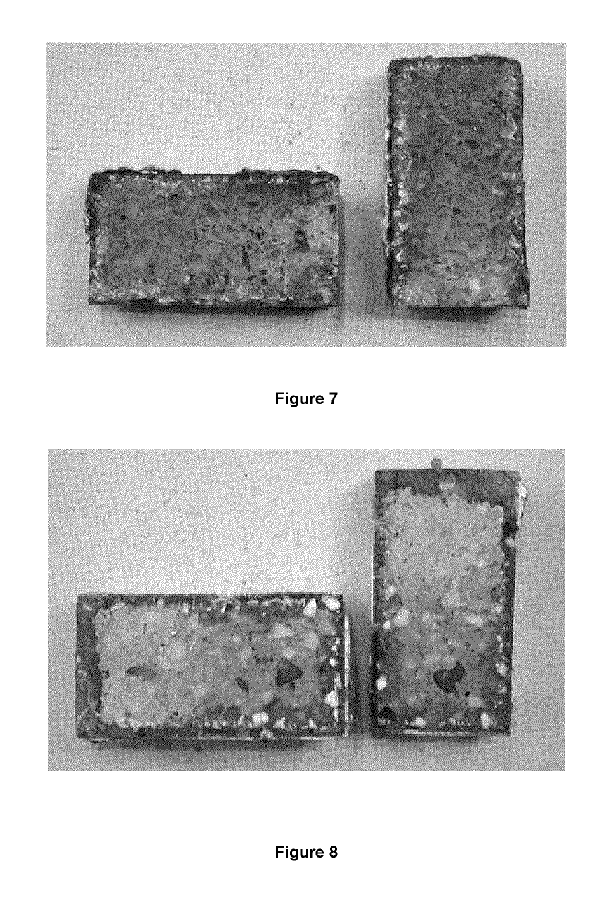

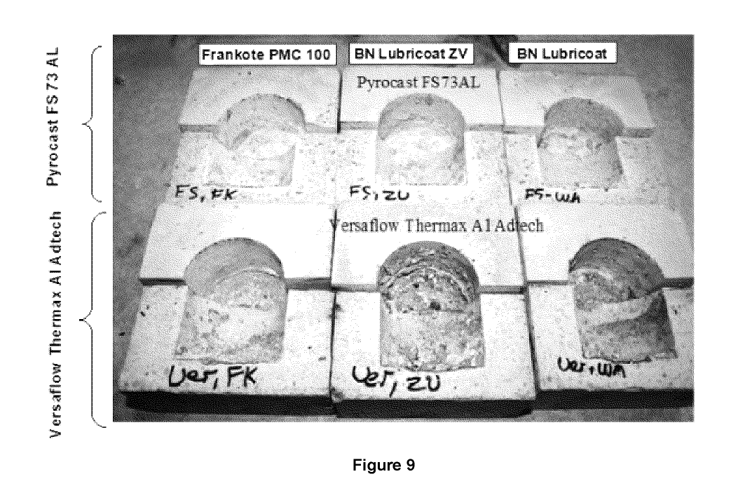

At the end of the four days, bricks were removed from the liquid aluminum-lithium alloy (1%). They were cut in two halves as in example 1. The visual aspect of bricks made of the refractory material A and brick made of the refractory material B were respectively shown in FIGS. 7 and 8. According to the “Alcan classification”, the brick made of the refractory material A were rated No. 3 and the bricks made of the refractory material B were rated No. 4. Thus, in the light of the preceding corrosion test, it appears that bricks made of the refractory material A showed a slight advantage compared to the bricks made of the refractory material B.

Also, from the above corrosion/immersion test, the bleached area noted in the test of the example 1 and in the sample of a launder no longer appears. This implies that the presence of oxygen was a factor for the formation of the bleached area.

Finally, it was noted that that a layer formed on the bricks showed moderate adherence to the refractory material and, therefore, was susceptible to be detached by a flow of liquid aluminum-lithium alloy (i.e. erosion).

### Example 3

Zr-20 C Refractory Material

The example 1 was repeated with a refractory material (hereinafter called Zr-20-C). This refractory material is a mixture of about 20 wt. % of aggregates and/or fines of zirconia; about 46 wt. % of aggregates and/or fines of alumina; about 34 wt. % of aggregates and/or fines of mullite; about 0.5 wt. % of aggregates and/or fines of calcium aluminate; and about 9 wt. % of a colloidal silica. The different ingredients were mixed in a Hobart mixer for 5 minutes and then cast to molds. The articles remained between 2 to 4 hours before demoulding the internal core, and then the articles were totally demoulded after 24 hours. All those steps of mixing and curing are made at room temperature.

Six samples as illustrated in FIG. 1 were prepared. Each sample was prepared by pouring an appropriate amount of the mixture into a mould, and then allowing said mixture to set at room temperature for 24 hours. Then, for the purpose of the present test, the 6 samples were divided in three groups of two samples. Each group was then subjected to a firing step at 750° C., 1200° C. or 1500° C. In this regard, it is to be noted that generally the Zr-20 C needs to be fired at 1500° C. However, for practical and economic reasons, the product was also fired at 750° C. and 1200° C. for the purpose of the present test.

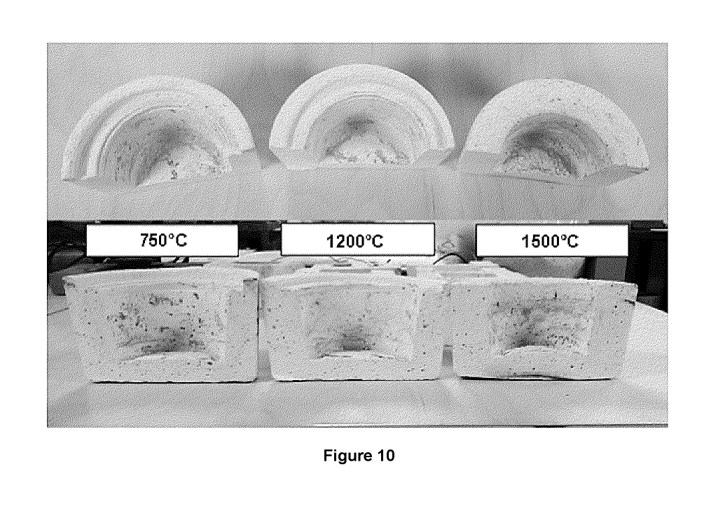

Corrosion tests of samples made of Zr-20 C fired at 750, 1200 and 1500° C. were carried out according to the procedure described in example 1 hereinabove for 4 days. Surprisingly, at the end of the test, as illustrated in the photograph of FIG. 10, the visual aspect of said samples showed no sign of corrosion or even of adherence by the liquid aluminum-lithium alloy (1%).

Thus, according to the “Alcan classification”, the corrosion resistance was rated No. 1. Also, when compared to samples A, B and C of example 1, the refractory material Zr-20 C surprisingly showed an excellent resistance to corrosion, particularly to the corrosive aluminum-lithium alloy (1%). Also, the absence of corrosion will prevent erosion of the samples.

It is to be noted that the Zr-20 C was known as a refractory material in the field of the glass manufacturing. Of course, glass manufacturing has nothing to do with the field of metallurgy and corrosion and/or erosion caused by liquid metal or liquid metal alloys, especially corrosive aluminum-lithium alloy (1%).

### Example 4

Thermal Conductivity

Because thermal conductivity is an important parameter for using refractory materials to embody article useful for the melting, transferring and/or casting of a metal or metal alloy, e.g. a launder for transferring a liquid aluminum alloy, the thermal conductivity of Zr-20 C was measured and compared with the one of a commercial product called Versaflow Thermax Al Adtech (described in example 1).

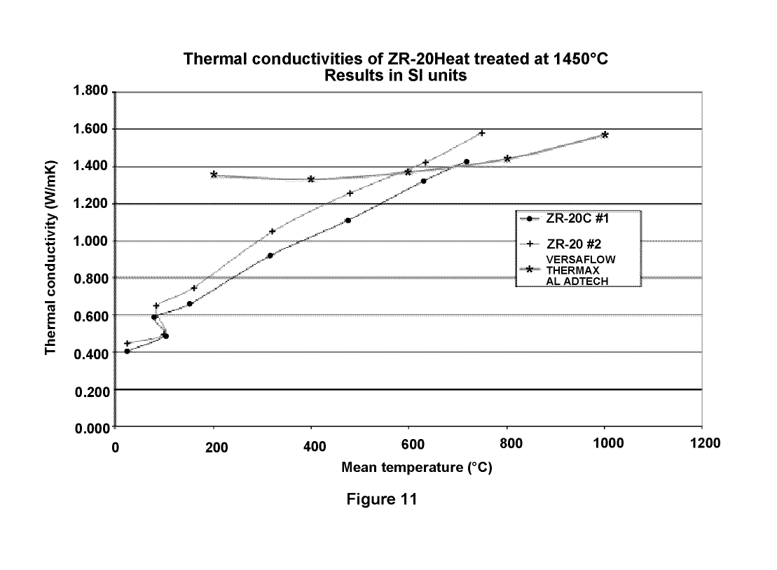

Results are shown in FIG. 11. The relative low thermal conductivity of Zr-20 C allow using it to embody an article use for melting, transferring and/or casting of a metal or metal alloy, especially a launder for transferring liquid aluminum or aluminum alloy.

Modulus of Rupture

The following table 1 shows maximum strength in flexion for Zr-20 C, after various firing temperature.

TABLE 1
Cold Modulus of rupture (CMOR)

| | Temperature (° C.) | | |
|---|---|---|---|
| | 750 | 1200 | 1500 |
| CMOR (MPa) | 13 | 19 | 20 |

For comparison purposes, the product Versaflow Thermax Al Adtech has a CMOR between 6 and 12 MPa, after firing at 815° C.

Density and Porosity

The following table 2 shows the density and the porosity of a product Zr-20 C, after various firing temperature.

TABLE 2

| | Temperature (° C.) | | |
|---|---|---|---|
| | 750 | 1200 | 1500 |
| Bulk density (g/cm³) | 3.05 | 3.01 | 3.00 |
| Porosity (vol. %) | 17.3 | 18.8 | 18.3 |

For comparison purposes, the product Versaflow Thermax Al Adtech has a density of about 2.0 g/cm³ after drying at 105° C.

Conclusion

Three different commercial products, Pyrocast FS73AL, Versaflow Thermax Al Adtech and Pyrocast FS44AL were tested. All these products showed a low resistance to corrosion by an aluminum-lithium alloy (1%).

Samples made of Zr20 C, fired at 750, 1200 and 1500° C. before being subjected to the test, surprisingly showed excellent properties of corrosion resistance to Al—Li alloy (1%), especially when compared to the conventional refractory materials A, B and C.

The present invention has been described with respect to its preferred embodiments. The description and the drawings are only intended to aid to the understanding of the invention and are not intended to limit its scope. It will be clear to those skilled in the art that numerous variations and modifications can be made to the implementation of the invention without being outside the scope of the invention. Such variations and modifications are covered by the present invention. The invention will be now described in the following claims:

1-15. (canceled)

16. Method for the manufacture of an article made of a refractory material for contact with a liquid metal or a liquid metal alloy,
wherein said method comprises the steps of:
a) providing a mixture comprising:
from 0 wt. % to 40 wt. % of aggregates and/or fines of zirconia;
from 10 wt. % to 50 wt. % of aggregates and/or fines of alumina; and
from 20 wt. % to 50 wt. % of aggregates and/or fines of mullite;
b) forming the mixture into a desired shape; and
c) subjecting the mixture obtained from step b) to a heating treatment at a temperature of from 750° C. to 1500° C.

17. The method of claim 16,
wherein the mixture comprises
from 5 wt. % to 40 wt. % of aggregates and/or fines of zirconia;
from 10 wt. % to 50 wt. % of aggregates and/or fines of alumina; and
from 20 wt. % to 50 wt. % of aggregates and/or fines of mullite;
a).

18. The method according to claim 16, wherein before step b) the mixture is further admixed with
from 0 to 15 wt. % fines and/or aggregates of calcium aluminate; and
from 0 to 20 wt. % of colloidal silica; and before step c) the formed mixture is allowed to set at room temperature between 4 to 24 hours.

19. The method of claim 17, wherein before the step b) the mixture is further admixed with
with from 0 to 15 wt. % fine and/or aggregates of calcium aluminate; and
from 0 to 20 wt. % of colloidal silica; and before step c) the formed mixture is allowed to set at room temperature between 4 to 24 hours.

20. The method of claim 19, wherein the mixture comprises a premix of
about 20 wt. % of aggregates and/or fines of zirconia;
about 46 wt. % of aggregates and/or fines of alumina; and
about 34 wt. % of aggregates and/or fines of mullite;
in admixture, with respect to the total weight of the premix, with
about 0.5 wt. %,of fine and/or aggregates of calcium aluminate; and
about 9 wt. % of a colloidal silica.

21. The method of claim 16, wherein the mesh size of aggregates of zirconia varies from 325 to 4 mesh, the mesh size of aggregates of alumina varies from 325 to 4 mesh, and the mesh size of aggregates of mullite varies from 325 to 4 mesh.

22. The method of claim 20, wherein the mesh size of aggregates of zirconia varies from 325 to 4 mesh, the mesh size of aggregates of alumina varies from 325 to 4 mesh, and the mesh size of aggregates of mullite varies from 325 to 4 mesh, the mesh size of aggregates of calcium aluminate is 325 to 4 mesh, and the colloidal silica has a solid weight content of about 40%.

23. The method of claim 16, wherein the zirconia is zirconium oxide, or the zirconia and the mullite are obtained from aggregates and/or fines forming a zirconia-mullite mixture.

24. The method of claim 16, wherein the refractory material is the constitutive material of an article for the melting, transfer and/or casting of said liquid metal or liquid metal alloy, said article having at least a portion thereof in direct contact with said liquid metal or liquid metal alloy.

25. The method of claim 16, wherein the liquid metal is a liquid aluminum, or wherein the liquid alloy is a liquid aluminum alloy.

26-30. (canceled)

31. An article made of a refractory material for contact with a liquid metal or a liquid metal alloy, wherein said refractory material is obtained from a mixture comprising:
from 0 wt. % to 40 wt. % of aggregates and/or fines of zirconia;
from 10 wt. % to 50 wt. % of aggregates and/or fines of alumina; and
from 20 wt. % to 50 wt. % of aggregates and/or fines of mullite;
formed into a desired shape and then subjected to a heating treatment at a temperature of from 750° C. to 1500° C.

32. The article of claim 31, wherein the mixture comprises:
from 5 wt. % to 40 wt. % of aggregates and/or fines of zirconia;
from 10 wt. % to 50 wt. % of aggregates and/or fines of alumina; and
from 20 wt. % to 50 wt. % of aggregates and/or fines of mullite.

33. The article of claim 32, wherein the mixture further comprises an amount of at least one of calcium aluminate and/or colloidal silica, and wherein the mixture after having been formed into the desired shape, has been allowed to set at room temperature between 4 and 24 hours, before being subjected to the heating treatment at the temperature of 750° C. to 1500° C.

34. The article of claim 33, wherein the calcium aluminate represents from 0 to 15 wt. % of the total weight of zirconia, alumina and mullite, and the colloidal silica represents from 0 to 20 wt. % of the total weight of zirconia, alumina and mullite.

35. The article of claim 34, wherein the mixture comprises:
about 20 wt. % of aggregates and/or fines of zirconia;
about 46 wt. % of aggregates and/or fines of alumina; and
about 34 wt. % of aggregates and/or fines of mullite;
about 0.5 wt. % of aggregates and/or fines of calcium aluminate; and
about 9 wt. % of a colloidal silica.

36. The article of claim 32, wherein the mesh size of aggregates of zirconia varies from 325 to 4 mesh, the mesh size of aggregates of alumina varies from 325 to 4 mesh, and the mesh size of aggregates of mullite varies from 325 to 4 mesh.

37. The article of claim 35, wherein the mesh size of aggregates of zirconia varies from 325 to 4 mesh, the mesh size of aggregates of alumina varies from 325 to 4 mesh, and the mesh size of aggregates of mullite varies from 325 to 4 mesh, the mesh size of aggregates of calcium aluminate is 325 to 4 mesh, and the colloidal silica has a solid weight content of about 40%.

38. The article of claim 31, wherein the zirconia is zirconium oxide, or the zirconia and the mullite are obtained from aggregates and/or fines forming a zirconia-mullite mixture.

39. The article of claim 31, wherein the refractory material is the constitutive material of the article for the melting, transfer and/or casting of said liquid metal or liquid metal alloy, said article having at least a portion thereof in direct contact with said liquid metal or liquid metal alloy.

40. The article of claim 31, wherein the liquid metal is a liquid aluminum, or wherein the liquid metal alloy is a liquid aluminum alloy.

41-45. (canceled)

46. A method for melting, transferring and/or casting a liquid metal or a liquid metal alloy, said method comprising a step of contacting the article of claim 31, with the liquid metal or the liquid metal alloy.

47. The method of claim 46, wherein the liquid metal is a liquid aluminum or wherein the liquid metal alloy is a liquid aluminum alloy.
